(19) United States
(12) Patent Application Publication
(10) Pub. No.: US 2007/0188859 A1
(43) Pub. Date: Aug. 16, 2007

(54) VISUAL INSPECTION APPARATUS

(75) Inventor: Hiroyuki TOKITA, Kamiina-gun (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: OLYMPUS CORPORATION, Tokyo (JP)

(21) Appl. No.: 11/674,846

(22) Filed: Feb. 14, 2007

(30) Foreign Application Priority Data
Feb. 15, 2006 (JP) P2006-037613

(51) Int. Cl. G02B 21/26

(52) U.S. Cl. 359/394

(57) ABSTRACT

A visual inspection apparatus is provided which is capable of obtaining an image oft a substrate at a predetermined position, in particular, a focused state of an image without using an aligning mechanism or an auto-focusing mechanism of specific use. A stage absorbs and holds a wafer. A stage-rotating mechanism rotates the stage. A first image-pickup section and a second image pickup section pick up images of the wafer with a first observational optical system and a second observational optical system respectively, and image signals are generated. An image-processing section and a deviation-amount-calculating section calculate a positional deviation amount of the second observational optical system from a position where a focus is obtained in the second image pickup section. The moving-mechanism-controlling section and the second moving mechanism control the position of the second observational optical system relative to the wafer based on the positional deviation amount.

The present application claims priority on patent application No. 2006-037613 filed in Japan Feb. 15, 2006, the content of which is incorporated herein by reference.

### BACKGROUND OF THE INVENTION

1. Field of the Invention

The present invention relates to a visual inspection apparatus for inspecting the appearance of substrates, e.g., semiconductor wafers.

2. Description of the Related Art

Defects such as flaws having occurred in a manufacturing process of substrates, e.g., semiconductor wafers are inspected by observing end faces of substrates as objects to be subjected to inspection. Such end faces are called beveled sections including side faces of substrates; front and back surfaces in the vicinity thereof; chamfered sections; and surfaces where unnecessary photo-resist is removed. An apparatus used (for inspecting such beveled sections) which is capable of observing end faces of semiconductor wafers has: a stage for mounting a wafer thereon; and a plurality of optical systems for picking up images of wafers (see Japanese Unexamined Patent Application, First Publication No. 2001-221749).

In a case where a substrate mounted on the stage has an eccentricity, that is, a rotational center of the stage and a rotational center of the substrate are inconsistent; an aligning mechanism positions the center of the substrate at a rotational center of a driving mechanism for rotating the stage. In order to observe a circumference of a wafer more strictly, the eccentricity is absorbed by consecutively moving the driving mechanism for driving the stage in X and Y directions, and then images are picked up. However, the X-Y stage cannot absorb warping occurring in a direction orthogonal with respect to the substrate. In order to address this case where the wafer should be observed in a plurality of directions, an auto-focusing mechanism must be further provided for compensating focus positions; however, such a configuration is problematic because it increases the cost. In addition, another problem may be caused because a position of an end face of a substrate having warping may vary along with the rotation of the stage; and an image of the end face picked up in a horizontal direction and displayed on a monitor can hardly be observed.

### SUMMARY OF THE INVENTION

The present invention was conceived in consideration of the above situation, and an object thereof is to provide a visual inspection apparatus continuously capable of obtaining an image of an end face of a substrate at predetermined positions without using an auto-focusing mechanism.

A visual inspection apparatus includes: a holding section for holding a substrate rotatively; first and second observational optical systems for observing the substrate; a first image-pickup section for picking up an image of the substrate from a first direction with the first observational optical system and generating a first image signal; a second image-pickup section for picking up an image of the substrate from a second direction with the second observational optical system and generating a second image signal so that the second direction is different from the first direction; a

positional-deviation-amount-calculating section for calculating a positional deviation amount of the substrate from a predetermined position on the image picked up by the first image-pickup section; and a relative-position-controlling section for controlling the position of the second observational optical system relative to the substrate so that the control of the relative position is based on the positional deviation amount calculated by the positional-deviation-amount-calculating section.

### BRIEF DESCRIPTION OF THE DRAWINGS

FIG. 1 is a block diagram showing the configuration of a visual inspection apparatus according to a first embodiment of the present invention.

FIGS. 2A and 2B illustrate for reference a method for controlling a focus point conducted by the visual inspection apparatus according to the first embodiment of the present invention.

FIGS. 3A and 3B illustrate for reference a method for controlling a focus point conducted by the visual inspection apparatus according to the first embodiment of the present invention.

FIG. 4 is a block diagram showing the configuration of the visual inspection apparatus according to a second embodiment of the present invention.

FIG. 5 is a block diagram showing the configuration of the visual inspection apparatus according to a third embodiment of the present invention.

FIG. 6 illustrates for reference a method for controlling a focus point conducted by the visual inspection apparatus according to third embodiment of the present invention.

FIG. 7 is a block diagram showing the configuration of the visual inspection apparatus according to a fourth embodiment of the present invention.

### DETAILED DESCRIPTION OF THE INVENTION

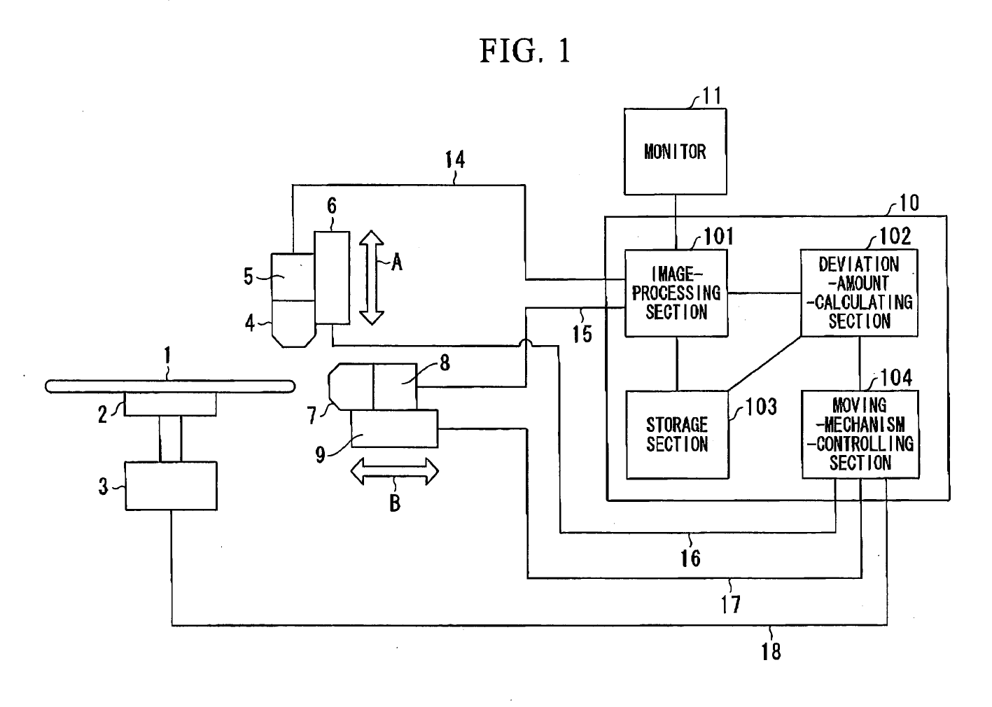

Embodiments of the present invention will be explained below with reference to the drawings. FIG. 1 shows the configuration of a visual inspection apparatus according to a first embodiment of the present invention. A wafer 1 as a semiconductor substrate, etc., is mounted on a stage 2. The stage 2 absorbs and holds the wafer 1. A stage-rotating mechanism 3 rotates the stage 2. The stage 2 and the stage-rotating mechanism 3 as means for holding the substrate hold the wafer 1 rotatively.

Provided for observing a periphery including an end face of the wafer 1 from two directions are two observational optical systems (a first observational optical system 4 and a second observational optical system 7). Although the optical axes of the observational optical systems provided in this configuration are orthogonal to each other, the angles defined by the optical axes may be arbitrary as long as the optical axes are not in parallel. The first observational optical system 4 and the second observational optical system 7 are each provided with optical elements such as lenses for condensing light incident from the wafer 1. In this configuration, the first observational optical system 4 is provided so as to observe an end face of the wafer 1 in a direction substantially orthogonal with respect to a primary surface of the wafer 1; and the second observational optical system 7 is provided so as to observe the end face of the wafer 1 in a direction substantially parallel with respect to the primary of the wafer 1. Although not shown in the drawing, a lighting apparatus may be provided. The lighting apparatus may be optical fibers introducing light from a light source or a plurality of LEDs. In addition, the observational optical systems may be constituted by a single focal length object lens unit used in a microscope or a zoom lens unit.

Light having been transmitted through the first observational optical system 4 is incident into an image-picking-up surface of a first image-pickup section 5, and light having been transmitted through the second observational optical system 7 is incident into an image-picking-up surface of a second image-pickup section 8. The first image-pickup section 5 and the second image-pickup section 8 each are provided with image-picking-up elements such as CCDs for picking up an image of the wafer 1 and generating an image signal. The first observational optical system 4 and the image-pickup section 5 can be unitarily moved into a direction indicated by an arrow A (in an optical axis direction of the first observational optical system 4) by means of the first moving mechanism 6 (relative-position-controlling section). Also, the second observational optical system 7 and the second image-pickup section 8 call be unitarily moved into a direction indicated by an arrow B (in an optical axis direction of the second observational optical system 7) by means of second moving mechanism 9 (relative-position-controlling section). The distance between the two observational optical systems and the wafer 1 is adjustable by means of the first moving mechanism 6 and the second moving mechanism 9.

The first image-pickup section 5 is connected to a controlling apparatus 10 through a video signal line 14, and the second image-pickup section 8 is connected to the controlling apparatus 10 through a video signal line 15. A first moving mechanism 6 is connected to the controlling apparatus 10 through a moving-mechanism-controlling signal line 16, and a second moving mechanism 9 is connected to the controlling apparatus 10 through a moving-mechanism-controlling signal line 17. The stage-rotating mechanism 3 is connected to the controlling apparatus 10 through a rotating-mechanism-controlling signal line 18.

Functions of the controlling apparatus 10 are controlling each component of the visual inspection apparatus and conducting various calculations. The image-processing section 101 in the controlling apparatus 10 obtains an image signal generated by the first image-pickup section 5 through the video signal line 14; obtains an image signal generated by the second image-pickup section 8 through the video signal line 15; and conducts an image processing for obtaining a luminance information which will be explained afterward.

A deviation-amount calculating section 102

(positional-deviation-amount-calculating section) calculates a positional deviation amount of an end section of the wafer 1 from a predetermined position of the picked-up image based on the luminance information obtained by the image-processing section 101. In the present embodiment, the positional deviation amount of the second observational optical system 7 is calculated based on how far the second observational optical system 7 is deviated from the predetermined position where a focus is obtained by the second image-pickup section 8. Although a focused image of the wafer 1 is picked up by the second image-pickup section 8 while the second observational optical system 7 is disposed at a position where the focus can be obtained by the second image-pickup section 8, the focusing position of the second observational optical system 7 relative to the focused point of the wafer 1 may be deviated from the position because of eccentricity and warping occurring on the wafer 1. The above-explained positional deviation amount is calculated to compensate for such a deviation. In addition, the deviation-amount-calculating section 102 has a function for calculating a positional deviation amount of the first observational optical system 4 from a focusing position of the first image-pickup section 5 similarly based on the image signal generated by the second image-pickup section 8.

A storage section 103 stores information, etc., based on which the deviation-amount-calculating section 102 can calculate the positional deviation amount. A moving-mechanism-controlling section 104 (relative-position-controlling section) controls the positions of the first observational optical system 4 and the first image-pickup section 5 in one unit by outputting control signals to the first moving mechanism 6 through the moving-mechanism-controlling signal line 16; and controls the positions of the second observational optical system 7 and the second image-pickup section 8 in one unit by outputting control signals to the second moving mechanism 9 through the moving-mechanism-controlling signal line 17. Furthermore, the moving-mechanism-controlling section 104 controls the rotative movement of the stage-rotating mechanism 3 by outputting control signals to the stage-rotating mechanism 3 through the rotating-mechanism-controlling signal line 18. Meanwhile, the relative-position-controlling section of the present embodiment is configured by the moving-mechanism-controlling section 104, the first moving mechanism 6, and the second moving mechanism 9.

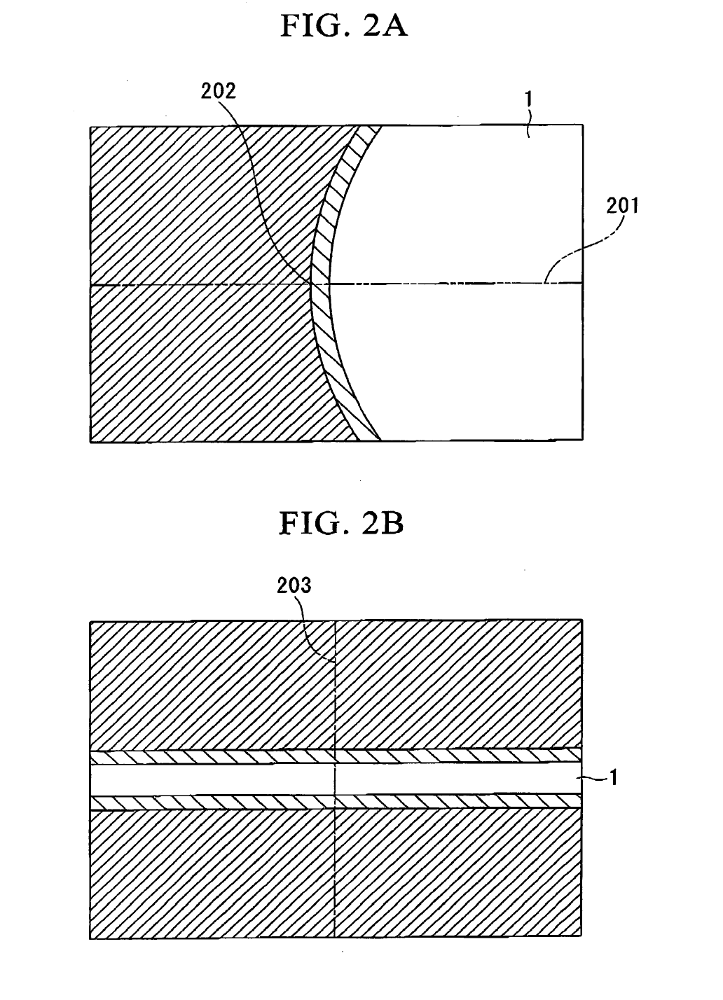

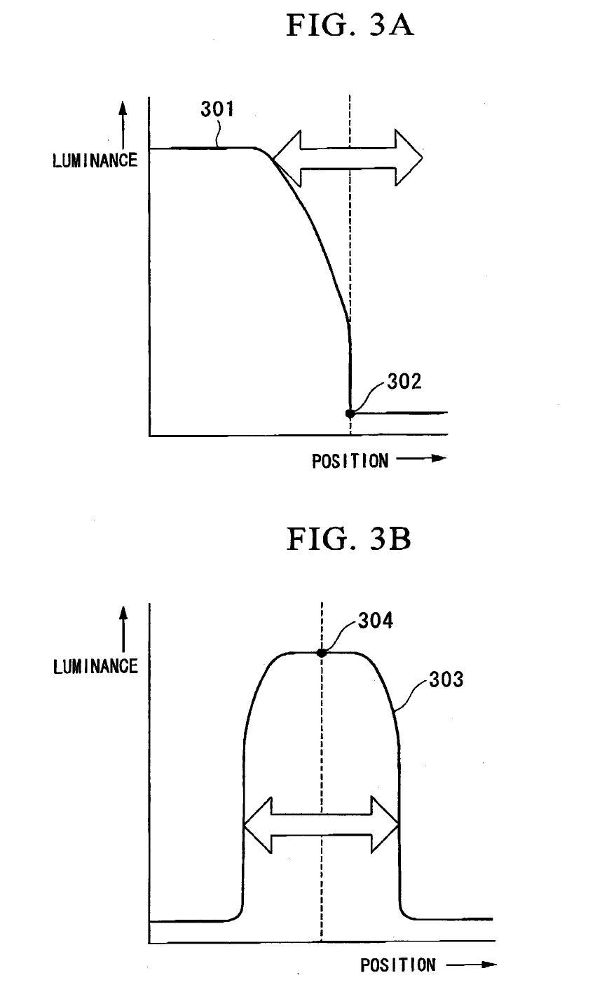

A method for controlling a focus in the present embodiment will be explained in next. FIG. 2A illustrates an image based on an image signal generated by the first image-pickup section 5. A comparatively bright portion of the image indicates a flat part of the primary surface of the wafer 1 while the dark portion of the image indicates that the wafer 1 does not exist there. The image-processing section 101 obtains luminance information corresponding to one line based on the image signal generated by the first image-pickup section 5. The luminance information indicates pixels along a line 201 as illustrated in FIG. 2A. FIG. 3A illustrates a distribution of the luminance.

The image-processing section 101 detects a characteristic point 302 where a curved line 301 indicating the luminance distribution represents a significant change of the luminance. The characteristic point 302 indicating the most significant change as shown in FIG. 3A may be obtained by, for example, differentiating the line indicating the luminance distribution. The characteristic point 302 corresponds to an end section 202 of the wafer 1. The information indicating the position of the characteristic point 302 detected by the image-processing section 101 is output to the deviation-amount calculating section 102. The deviation-amount calculating section 102 traces how the position of the characteristic point 302 changes. That is, the deviation-amount-calculating section 102 calculates by how many pixels the position of the characteristic point 302 (to be referred to as a reference position) is deviated from the focusing position of the second image-pickup section 8.

It is necessary in advance to obtain the reference position, where the second image-pickup section 8 obtains a focus, of the characteristic point 302 on the luminance distribution prior to calculating the above positional deviation amount. For example, the image-processing section 101 detects the position of the characteristic point 302 obtained based on the image signal generated by the first image-pickup section 5 and indicated in the luminance distribution under the condition that the second observational optical system 7 and the second image-pickup section 8 are previously disposed so that the second image-pickup section 8 can obtain a focus. The position of the characteristic point 302 under the current state is correlated to the position of the second observational optical system 7, and the storage section 103 stores the correlated position as an indicative of the reference position. Following that, in a case where a new image signal is generated in the first image-pickup section 5, the deviation-amount-calculating section 102 retrieves information indicative of the reference position from the storage section 103, calculates how many pixels the position indicating the newly obtained characteristic point 302 is deviated by from the reference position, and outputs information indicative of the positional deviation amount to the moving-mechanism-controlling section 104.

The moving-mechanism-controlling section 104 calculates an actual distance between the reference position and the characteristic point 302 based on the information indicative of the positional deviation amount and a distance between a pair of pixels, and converts the calculated distance into a moving amount caused by the second moving mechanism 9 with respect to the second observational optical system 7 and the second image-pickup section 8. The second moving mechanism 9 moves the second observational optical system 7 and the second image-pickup section 8 in accordance with the converted moving amount. This movement allows the second image-pickup section 8 to obtain a focused state of the image. Constant distances can be maintained among the wafer 1, the second observational optical system 7, and the second image-pickup section 8 by repeating the above processes along with the rotation of the wafer 1.

The position of the first observational optical system 4 and the position of the first image-pickup section 5 are controlled based on the image picked up by the second image-pickup section 8 in a way similar to the above explanation. FIG. 2B illustrates an image based on the image signal generated by the second image pickup section 8. A comparatively bright portion of the image indicates a part of the end face of the wafer 1 while the dark portion of the image indicates that the wafer 1 does not exist there. The image-processing section 101 obtains a luminance information corresponding to one line of pixels based on the image signal generated by the second image-pickup section 8. The luminance information indicates pixels along a predetermined line 203 as illustrated in FIG. 2B. FIG. 3B illustrates a distribution of the luminance.

The image-processing section 101 specifies a characteristic point 304 on a curved line 303 describing the luminance distribution. The characteristic point 304 corresponds to a middle point between two regions where the luminance shows a significant change, and also, the characteristic point 304 corresponds to a center of the end face of the wafer 1. The characteristic point 304 may be obtained by differentiating the curve indicative of the luminance distribution as shown in FIG. 3B, extracting two points showing significant changes, and calculating the middle point between these two points. The information indicative of the position of the characteristic point 304 detected by the image-processing section 101 is output to the deviation-amount calculating section 102. The deviation-amount-calculating section 102 calculates by how many pixels the position of the characteristic point 304 is deviated from the reference position.

For example, the image-processing section 101 specifies the position of the characteristic point 304 obtained based on the image signal generated by the second image-pickup section 8 and indicated in the luminance distribution under the condition that first observational optical system 4 and the first image-pickup section 5 are previously disposed so that the second image-pickup section 5 can obtain a focus. The position of the characteristic point 304 under the current state is correlated to the position of the first observational optical system 4, and the storage section 103 stores the correlated position indicative of the reference position. Following that, in a case where a new image signal is generated in the second image-pickup section 8, the deviation-amount-calculating section 102 retrieves information indicative of the reference position from the storage section 103, calculates by how many pixels the position indicating the newly obtained characteristic point 304 is deviated from the reference position, and outputs an information indicative of the positional deviation amount to the moving-mechanism-controlling section 104.

The moving-mechanism-controlling section 104 calculates an actual distance between the reference position and the characteristic point 302 based on the information indicative of the positional deviation amount and a distance between a pair of pixels, and converts the calculated distance into a moving amount caused by the first moving mechanism 6 with respect to the first observational optical system 4 and the first image-pickup section 5. The first moving mechanism 6 moves the first observational optical system 4 and the first image-pickup section 5 in accordance with the converted moving amount. This movement allows the first image-pickup section 5 to obtain a focused state of the image. Constant distances can be maintained among the wafer 1, the first observational optical system 4, and the first image-pickup section 5 by repeating the above processes along with the rotation of the wafer 1.

The end face of the wafer 1 picked up in this context and displayed on a monitor 11 (display section) will be visually inspected by an inspector. In addition, a defect-detecting section may be disposed in the image-processing section 101 for detecting an abnormality in luminance data and outputting the result of detection to the monitor 11.

As previously described, the visual inspection apparatus according to the present embodiment is provided with at least two observational optical systems and two image-pickup sections for observing and picking up images of parts of the wafer 1 including the end face thereof from at least two directions. Therefore, the visual inspection apparatus calculates the positional deviation amount of the first observational optical system 4 (or the second observational optical system 7) from the position where the first image-pickup section 5 (or the second image-pickup section 8) can obtain a focus based on the image signal generated by the second image-pickup section 8 (or the first image-pickup section 5), and controls the position of the first observational optical system 4 (or the second observational optical system 7) relative to the substrate based on the calculated positional deviation amount. A concurrent processing method or alternate high-speed processing method may be used for controlling the first observational optical system 4 and the second observational optical system 7.

To be more specific, a characteristic point is at first specified on the luminance distribution along a line crossing the picked up image of the end face (or the surface) of the wafer 1. After that, the positional deviation is calculated indicative of the above deviation amount of the characteristic point from the reference position where the second image-pickup section 8 (or the fist image-pickup section 5) can obtain a focus. Therefore, an inexpensive visual inspection apparatus can be which is realized capable of obtaining an image of an end surface of the substrate at a predetermined position, in particular, a focused state of an image quickly without using an aligning mechanism or an auto-focusing mechanism. According to the present embodiment, since the position of the first observational optical system 4 and the position of the second observational optical system 7 are controlled independently, concurrent processing of the position control can provide a high-speed rotation of the substrate subjected to picking up of an image.

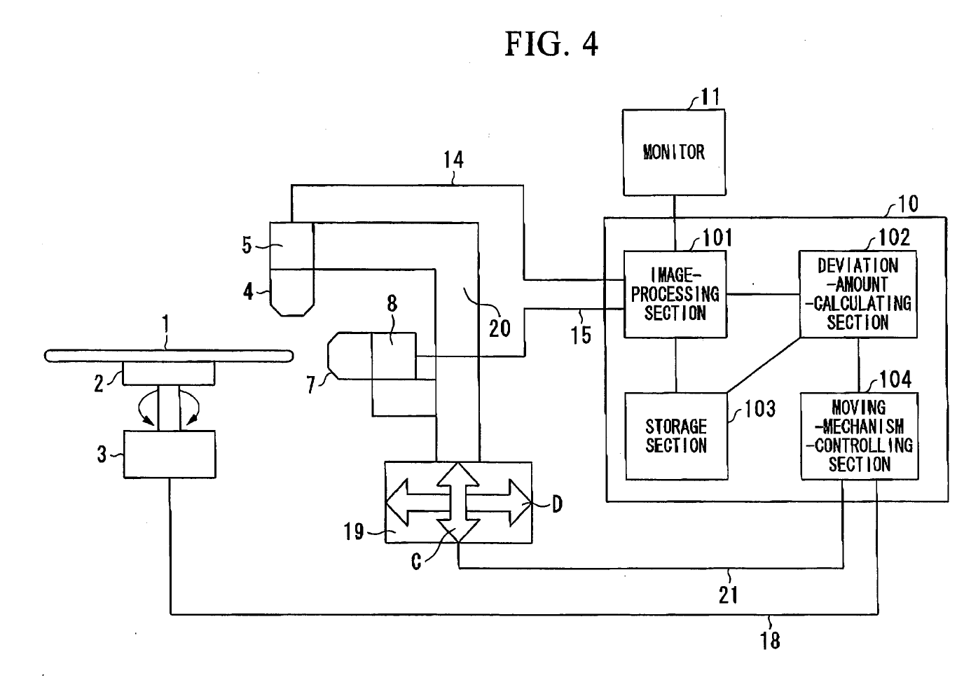

A second embodiment of the present invention will be explained next while focusing on the difference from the first embodiment. FIG. 4 is a schematic diagram of the visual inspection apparatus according to the present embodiment. In the present embodiment, an optical system/image-pickup-system-connecting section 20 (connecting section) connects and fixes the first observational optical system 4 to the first image-pickup section 5, and also connects and fixes the second observational optical system 7 to the second image-pickup section 8. The positions of the second observational optical system 7 and the second image-pickup section 8 relative to the first observational optical system 4 and the first image-pickup section 5 are regularly fixed since these components move in one unit. It should be noted that slight rotational change and positional change may be imparted as long as the fixed condition is maintained among these components.

An optical system/image-pickup-system-moving mechanism 19 is connected to the optical system/image-pickup-system-connecting section 20. The moving mechanisms used in this configuration are constituted by commonly known technologies. For example, ball screws and linear motors may be used. The two observational optical systems, image-pickup sections, and the optical system/image-pickup-system-connecting section 20 are capable of moving as one unit by means of the optical system/image-pickup-system-moving mechanism 19 in directions indicated by C and D. The optical system/image-pickup-system-moving mechanism 19 is connected to the controlling apparatus 10 through a moving-mechanism-controlling signal line 21. The moving-mechanism-controlling section 104 in the controlling apparatus 10 controls the positions of two observational optical systems, the image pickup sections, and the optical system/image-pickup-system-connecting section 20 as one unit by outputting a control signal to the optical system/image-pickup-system-moving mechanism 19 through the moving-mechanism-controlling signal line 21.

The method for controlling a focus to obtain a focused image used in the first image-pickup section 5 and the second image-pickup section 8 is the same as that of the first embodiment. Since two observational optical systems and the image pickup sections move as one unit in the present embodiment, the first observational optical system 4 and the first image-pickup section 5 move correspondingly, with respect to the moving direction and moving amount, to the movement of the second observational optical system 7 and the second image-pickup section 8 along the optical axis in the second observational optical system 7. Similarly, the second observational optical system 7 and the second image-pickup section 8 also move correspondingly with respect to the moving direction and moving amount, to the movement of the first observational optical system 4 and the first image-pickup section 5 along with the optical axis in the same direction.

The wafer 1, even if it is rotating, can therefore be observed so that the constant distances among the rotating wafer 1 and the observational optical systems are maintained and the wafer 1 does not move on the picked up image due to eccentricity and warping. In a case where, for example, an end of the wafer 1 moves in a direction indicated by an arrow D due to the eccentricity or warping, the second observational optical system 7 and the second image-pickup section 8 move in the same direction for adjusting a focusing point in accordance with the movement of the wafer 1. Unless controlled otherwise, the position of the first observational optical system 4 with respect to the primary surface of the wafer 1 subject to the observation may be deviated, and the wafer 1 may thus move horizontally or vertically in a displayed image picked up by the first image-pickup section 5.

However, the present embodiment can provide the maintained position of the wafer 1 in the image picked up by the first image-pickup section 5 since the first observational optical system 4 and the first image-pickup section 5 move in the same direction by the same movement amount as the second observational optical system 7 and the second image-pick section 8. This configuration is applicable to the image picked up by the second image-pickup section 8. The present embodiment is advantageous in providing a significant magnification ratio of observation since the constant position of the wafer 1 can be maintained in the picked up image. Since a whole unit including the first observational optical system 4, the first image-pickup section 5, the second observational optical system 7, and the second image-pickup section 8 can move by using one of the signals supplied from the first image-pickup section 5 and the signal supplied from the second image-pickup section 8 while switching both signals at high speed based on a time-sharing method or by using the signals supplied from the image-pickup sections while concurrently processing them, this configuration therefore provides observation of the wafer 1 from constant positions by a constant focusing point. Also, it is possible to fuse the images without difficulty obtained over a circumference of the wafer 1 and stored in the storage section 103.

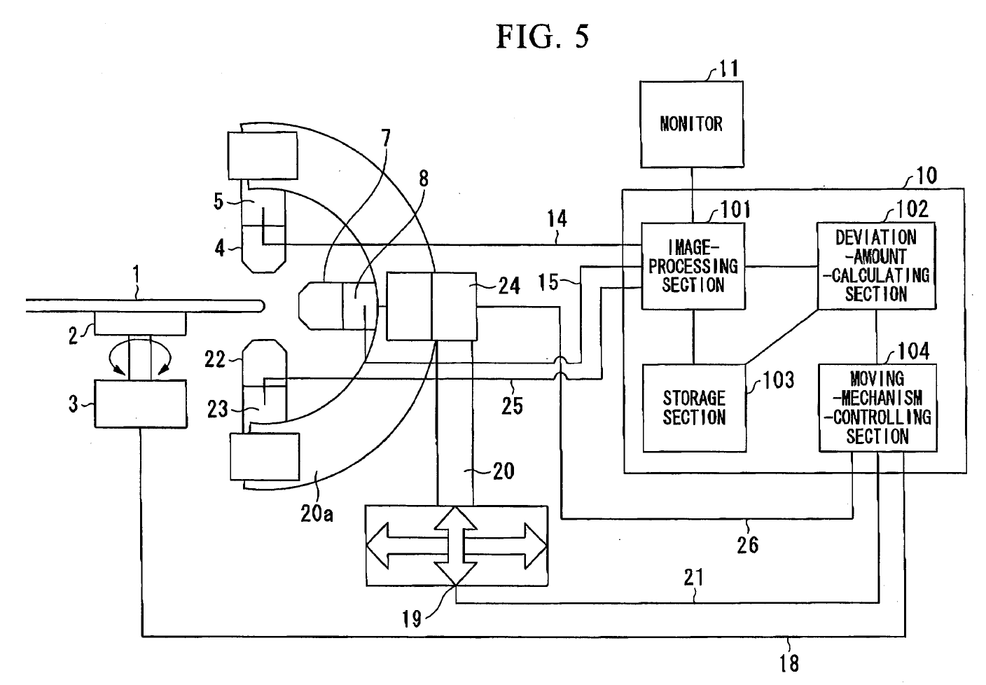

A third embodiment of the present invention will be explained next while focusing on the difference from the second embodiment. FIG 5 is a schematic diagram of the visual inspection apparatus according to the present embodiment. A third observational optical system 22, a third image-pickup section 23, and an angle-adjusting mechanism 24 are provided to the present embodiment in contrast to the visual inspection apparatus according to the second embodiment. The third observational optical system 22 and the third image-pickup section 23 are disposed so as to face the first observational optical system 4 and the first image-pickup section 5. The third image-pickup section 23 is connected to the controlling apparatus 10 through a video signal line 25 so that an image signal generated by the third image-pickup section 23 is input into the image-processing section 101 in the controlling apparatus 10. This configuration allows picking up of an image of the wafer 1 from the downside.

The image-processing section 101 detects information indicative of the position, etc. of the characteristic point on the luminance distribution based on the image signal generated by the image pickup sections similarly to the first embodiment. The deviation-amount-calculating section 102 calculates inclinational deviation (angular deviation) of the wafer 1 with respect to a reference inclination based on information (including the characteristic point on the luminance distribution) obtained based on the image signal generated by the first image-pickup section 5 and the third image-pickup section 23. The deviation-amount-calculating section 102 outputs the information indicative of the calculated angular deviation of the wafer 1 to the

moving-mechanism-controlling section 104.

An angle-adjusting mechanism 24 is provided to the optical system/image-pickup-system-connecting section 20. An arm 20a of the optical system/image-pickup-system-connecting section 20 rotates around a point where the optical axes of three observational optical systems cross each other by means of the angle-adjusting mechanism 24 so that the inclination of the wafer 1 is controlled relative to the observational optical systems and image pickup sections, more specifically the second observational optical system 7 and the second image-pickup section 8. Based on this controlling scheme, the second image-pickup section 8 first picks up an image under the condition that inclinations of the observational optical systems and image pickup sections relative to the wafer 1 are set to be a reference inclination (reference angle). The image-processing section 101 detects information (luminance distribution, etc., obtained based on the image signal) required for controlling the inclination based on the image signal generated by the second image-pickup section 9. The detected information associated with the reference inclination is stored in the storage section 103. For example, the storage section 103 stores the luminance distribution associated with the position of the second observational optical system 7.

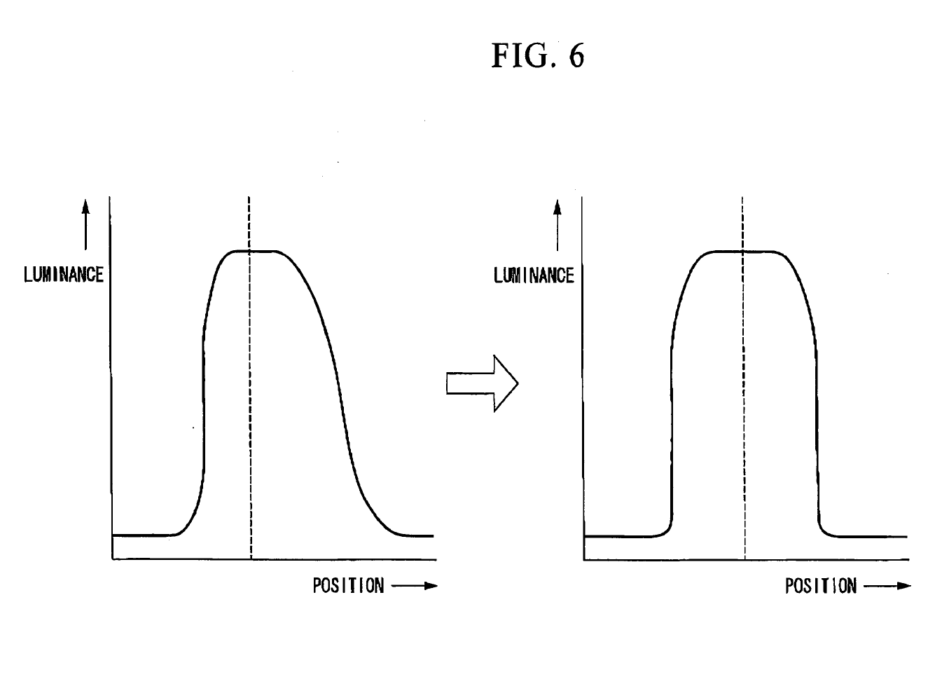

Following this, the deviation-amount-calculating section 102 retrieves the information indicative of the reference inclination from the storage section 103. As shown in FIG. 6, the deviation-amount-calculating section 102 calculates the areas divided in two sides at a center line passing through a peak of a line indicative of the luminance distribution of the image picked up by the second image-pickup section S. Furthermore, the deviation-amount-calculating section 102 calculates the angular deviation corresponding to a ratio between two areas and notifies the calculated angular deviation to the moving-mechanism-controlling section 104. The moving-mechanism-controlling section 104 rotates the arm 20a around the point where the optical axes of three observational optical system cross each other so that the second observational optical system 7 moves toward a smaller one of the two sides of the divided area of the luminance distribution until the two areas are equal. The moving-mechanism-controlling section 104 consequently rotates the arm 20a while calculating the angular deviation of the image picked up by the second image-pickup section 8 at high speed, and stops the rotation when the two areas are equal in the luminance distribution. The inclination of the wafer 1 with respect to the reference is compensated accordingly.

The angle-adjusting mechanism 24 is connected to the moving-mechanism-controlling section 104 in the controlling apparatus 10 through an angle-controlling signal line 26. The moving-mechanism-controlling section 104 outputs a control signal to the angle controlling signal line 26 and sends an instruction to the angle-adjusting mechanism 24 to rotate the arm 20a so that the arm 20a is rotated to compensate for the inclinational deviation of the wafer 1, with respect to the reference, calculated by the deviation-amount calculating section 102. The angle-adjusting mechanism 24 having received the instruction changes the inclination of the arm 20a by a designated angle.

As previously explained, since the second observational optical system 7 and the second image-pickup section 8 maintain constant angles relative to the wafer 1, the constant brightness of the picked up image subjected to observation by the second image-pickup section 8 can be maintained as long as a lighting apparatus and the second observational optical system 7 are configured to be one unit so as to move concurrently. Alternatively, a rotational mechanism may be provided to the stage 2 as long as the second observational optical system 7 and the second image-pickup section 8 have controlled angles relative to the wafer 1.

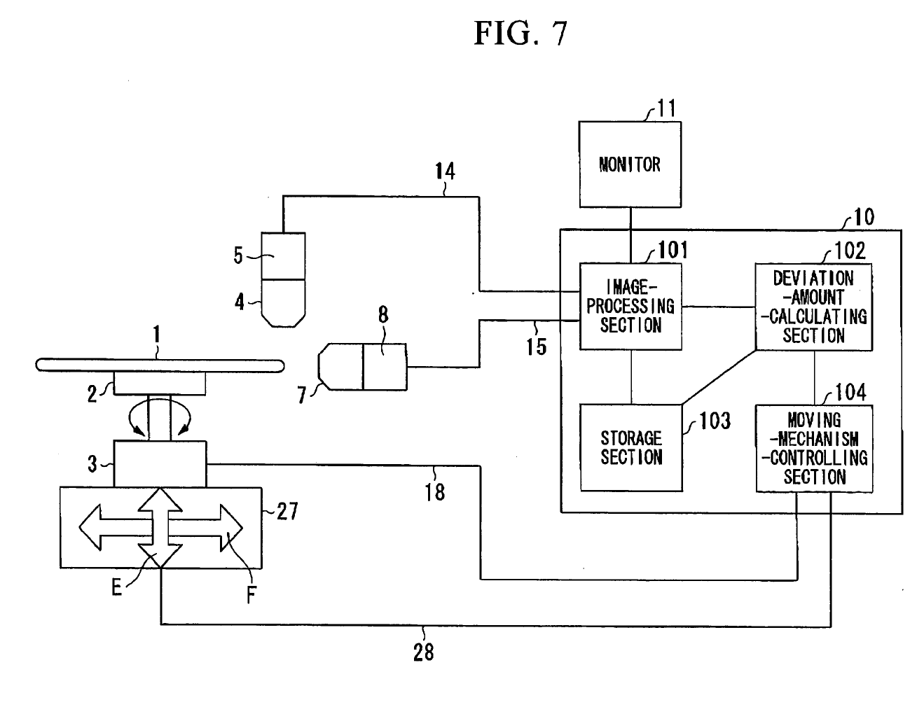

A fourth embodiment of the present invention will be explained next. FIG. 7 is a schematic diagram of the visual inspection apparatus according to the present embodiment. A stage-moving mechanism 27 (a relative-position-controlling section) is provided to the present embodiment in contrast to the visual inspection apparatus according to the first embodiment. The stage-moving mechanism 27 disposed beneath the stage-rotating mechanism 3 moves an entire unit including the wafer 1, the stage 2, and the stage-rotating mechanism 3 in directions (indicated by arrows E and F) along the optical axes of two observational optical systems. The stage-moving mechanism 27 is connected to the moving-mechanism-controlling section 104 in the controlling apparatus 10 through the stage-moving-mechanism-controlling signal line 28.

The information indicative of the positional deviation amount detected based on the image signal generated by the first image-pickup section 5 is output from the deviation-amount-calculating section 102 to the moving-mechanism-controlling section 104 similarly to the first embodiment. The moving-mechanism-controlling section 104 converts the positional deviation amount into a distance between of the wafer 1 picked up by the second image-pickup section 8 and the reference position on the image by taking the information indicative of the positional deviation amount and the distance between a pair of pixels into consideration. The moving-mechanism-controlling section 104 further sends an instruction to the stage-moving mechanism 27 to move in the converted distance. The stage-moving mechanism 27 moves the entire unit including the wafer 1, the stage 2, and the stage-rotating mechanism 3 based on the instruction in a direction of the optical axis of the second observational optical system 7 by the above converted distance.

This movement allows the second image-pickup section 8 to obtain a focused state of an image. Constant distances can be maintained among the wafer 1, the second observational optical system 7, and the second image-pickup section 8 by repeating the above processes along with the rotation of the wafer 1. This configuration is applicable to a case where the entire unit including the wafer 1, the stage 2, and the stage-rotating mechanism 3 is moved in a direction of the optical axis of the first observational optical system 4 so as to obtain a focus in the first image-pickup section 5. An inexpensive visual inspection apparatus can be realized in the present embodiment since a focused image subjected to the observation can be regularly obtained by merely adding a minimum component to a configuration having mechanisms for driving the stage 2 which handles transporting of the wafer 1.

The embodiments of the present invention have been explained above in details with reference to the drawings. However, it should be understood that the drawings and detailed description thereto are not intended to limit the invention to the particular form disclosed; thus, the invention disclosed herein is susceptible to various modifications and alternative forms, i.e., design changes. Although lighting apparatuses will not be limited with respect to the number and type used in the present invention, for example, it is preferable to use a coaxial epi-illumination system using a half mirror in the middle of the optical axis. Also, the first image-pickup section 5 and the second image-pickup section 8 may be formed by two-dimensionally disposed pixels or by one-dimensionally disposed pixels forming a so-called line sensor. The longitudinal length of a line sensor used in this case should be orthogonal to a direction in which the image of the wafer 1 moves. The two dimensional image can be formed by rotating the wafer 1. Although the position where a focus can be obtained in the image pickup section has previously been exemplified as the predetermined position on the picked up image, the predetermined position may be in an arbitrary position in the image, e.g., a position where an end of the image of the wafer 1 comes to a center of the displayed image.

The present invention provides an effect in that the image of the end of the substrate can be obtained at the predetermined position without using an auto-focusing mechanism.

What is claimed is:

1. A visual inspection apparatus comprising:
a holding section for holding a substrate rotatively;
first and second observational optical systems for observing the substrate;
a first image-pickup section for picking up an image of the substrate from a first direction with the first observational optical system and generating a first image signal;
a second image-pickup section for picking up an image of the substrate from a second direction with the second observational optical system and generating a second image signal, the second direction being different from the first direction;
a positional deviation-detecting section for calculating a positional deviation amount of the substrate from a predetermined position on the image picked up with the first image-pickup section; and
a relative-position-controlling section for controlling the position of the second observational optical system relative to the substrate, the control of the relative position being based on the positional deviation amount calculated by the positional deviation-amount-calculating section.

2. The visual inspection apparatus according to claim 1, wherein the predetermined position on the picked up image indicates so that the second image-pickup section can obtain a focus.

3. The visual inspection apparatus according to claim 2, further comprising a connecting section for connecting the first observational optical system to the second observational optical system, the position of the second observational optical system relative to the first observational optical system being fixed.

4. The visual inspection apparatus according to claim 1, further comprising a connecting section for connecting the first observational optical system to the second observational optical system, the position of the second observational optical system relative to the first observational optical system being fixed.

5. The visual inspection apparatus according to claim 1, wherein the relative-position-controlling section controls the position of the second observational optical system relative to the substrate by moving the second observational optical system.

6. The visual inspection apparatus according to claim 1, wherein the relative-position-controlling section controls the position of the second observational optical system relative to the substrate by moving the substrate.

7. The visual inspection apparatus according to claim 1, further comprising:
an angular-deviation-amount calculating section for calculating an angular deviation amount of the substrate relative to a reference based on the image signal generated by one of the first image-pickup section and the second image-pickup section; and
an inclination-controlling section for controlling the inclination of the substrate based on the inclinational deviation amount calculated by the angular-deviation-amount calculating section.

8. The visual inspection apparatus according to claim 1, wherein
the first observational optical system is disposed to observe an end surface of the substrate from a direction substantially orthogonal to a primary surface of the substrate; and
the second observational optical system is disposed to observe the end surface of the substrate from a direction substantially in parallel with the primary surface of the substrate.

9. The visual inspection apparatus according to claim 3, wherein the first image-pickup section and the second image-pickup section pick up the images of the substrate at regular positions by calculating the deviation amounts so that the signal from the first image-pickup section and the signal from the second image-pickup section are processed by alternating the data using a time-sharing method or by calculating concurrently.

10. The visual inspection apparatus according to claim 4, wherein the first image-pickup section and the second image-pickup section pick up the images of the substrate at regular positions by calculating the deviation amounts so that the signal from the first image-pickup section and the signal from the second image-pickup section are processed by alternating the data using a time-sharing method or by calculating concurrently.

11. The visual inspection apparatus according to claim 7, wherein the angular-deviation-amount detecting section further calculates an inclinational deviation amount of the substrate relative to a reference based on information indicative of the luminance distribution of the captured image.
